(19) United States
(12) Patent Application Publication
(10) Pub. No.: US 2017/0287453 A1
(43) Pub. Date: Oct. 5, 2017

(54) MUSICAL SCORE DISPLAY CONTROL METHOD, DEVICE AND PROGRAM

(71) Applicant: Yamaha Corporation, Hamamatsu Shizuoka (JP)

(72) Inventor: Norihiro UEMURA, Hamamatsu (JP)

(21) Appl. No.: 15/468,980

(22) Filed: Mar. 24, 2017

(30) Foreign Application Priority Data
Mar. 30, 2016 (JP) 2016-067696

(51) Int. Cl. G10G 1/00; G10H 1/00

(52) U.S. Cl. CPC G10G 1/00; G10H 1/0008; G10H 2210/091; G10H 2220/015

(57) ABSTRACT

A musical score display control method, device and program which control a processor to acquire performance data being performed, sequentially acquire performance positions of a performance in a musical score data that represent a musical score based on the musical score data and the performance data, and display on a display a predetermined portion of the musical score data according to the current performance position. The processor also controls the display to display a next performance target portion of the musical score data upon determining that the current performance position has advanced beyond a first threshold position from a prior performance position at a point in time prior to the current performance position, and to display a previous performance target portion of the musical score data upon determining that the current performance position has returned beyond a second threshold position from the prior performance position.

### CROSS-REFERENCE TO RELATED APPLICATION

This application claims the benefit of Japanese Patent Application No. 2016-067696, filed on Mar. 30, 2016, the entire contents of Japanese Patent Application No. 2016-067696 being incorporated herein by reference.

### BACKGROUND

### Field of the Invention

The present invention relates to a musical score display control method, device, and program that improve visibility of a displayed musical score. More particularly, the present invention relates to a musical score display control method, device and program that improve the visibility of the musical score when an update of the display of the musical score is carried out in time with performance of the musical score.

### Description of the Related Art

Japanese Laid-Open Patent Publication No. 2001-265325 discloses a musical score display device that automatically updates the display of a musical score according to the performance position in the musical score. Specifically, in the musical score display device, musical sounds, including voice and the performance sound of an instrument that is emitted from the instrument via a speaker, are acquired by a microphone. Through analysis of the acquired musical sound, the performance position of the musical sound is then identified and the updating of the display of the musical score is automatically carried out based on the performance position. The updating of the display of the musical score is carried out, for example, by updating the musical score, which includes a plurality of bars, half a page at a time, according to the progress of the performance. Specifically, when half a page of a musical score, which includes a plurality of bars, is displayed in a display area that is divided into first and second grand staffs, one upper and one lower, if an attention position corresponding to the progress of the performance passes a virtually set boundary line, the succeeding next half page of the musical score is displayed, etc.

### SUMMARY

When updating of the display of the musical score, such as that described above, is carried out, an updating of the display of the page occurs when the current performance position passes a page update boundary line from the immediately prior performance position. In addition, when returning to a performance position before the immediately prior performance position, when viewed from the performance direction, due to a repetition of a performance by the performer (for example, re-playing), updating of the displayed page also occurs when the current performance position passes a page update boundary line. In cases such as the above, each time that the boundary line is passed, a screen transition occurs, and there is the risk that the visibility of the musical score becomes compromised for the user.

In view of the problem described above, the present invention realizes a musical score display control method, controller, program or the like, that is able to improve the visibility of the musical score by the user, for example, when an update of the display of the musical score is carried out in time with the performance.

The musical score display control method according to a disclosed embodiment comprises acquiring by a processor performance data being performed, sequentially acquiring by the processor performance positions, including a current performance position, of a performance in a musical score data that represent a musical score based on the musical score data and the performance data, and displaying on a display a predetermined portion of the musical score data as controlled by the processor according to the current performance position acquired by the processor. The method also comprises displaying on the display a next performance target portion of the musical score data, corresponding to a next performance target on the musical score data, as controlled by the processor upon the processor determining that the current performance position has advanced beyond a first threshold position from a prior performance position at a point in time in the musical score data prior to the current performance position. The method further comprises displaying on the display a previous performance target portion of the musical score data, corresponding to a previous performance target on the musical score data, as controlled by the processor upon the processor determining that the current performance position has returned beyond a second threshold position from the prior performance position.

In addition, the musical score display controller according to a disclosed embodiment comprises a processor, programmed to acquire performance data being performed, sequentially acquire performance positions, including a current performance position, of a performance in a musical score data that represent a musical score based on the musical score data and the performance data, and control a display to display a predetermined portion of the musical score data according to the current performance position acquired by the processor. The processor is also programmed to control the display to display a next performance target portion of the musical score data, corresponding to a next performance target on the musical score data, upon the processor determining that the current performance position has advanced beyond a first threshold position from a prior performance position at a point in time in the musical score data prior to the current performance position. The processor is further programmed to control the display to display a previous performance target portion of the musical score data, corresponding to a previous performance target on the musical score data, upon the processor determining that the current performance position has returned beyond a second threshold position from the prior performance position.

Furthermore, the musical score display control program according to a disclosed embodiment provides non-transitory computer-readable medium storing a musical score display control program that is executed by a computer to acquire performance data being performed, sequentially acquire performance positions, including a current performance position, of a performance in a musical score data that represent a musical score based on the musical score data and the performance data, and control a display to display a predetermined portion of the musical score data according to the current performance position acquired by the computer. Also, the musical score display control program is executed by a computer to control the display to display a next performance target portion of the musical score data, corresponding to a next performance target on the musical score data, upon the computer determining that the current performance position has advanced beyond a first threshold position from a prior performance position at a point in time in the musical score data prior to the current performance position. Furthermore, the musical score display control program is executed by a computer to control the display to display a previous performance target portion of the musical score data, corresponding to a previous performance target on the musical score data, upon the computer determining that the current performance position has returned beyond a second threshold position from the prior performance position.

### BRIEF DESCRIPTION OF THE DRAWINGS

Referring now to the attached drawings which form a part of this original disclosure:

FIG. 1 illustrates an example of a musical score display control device according to a disclosed embodiment;

FIG. 2 is a block diagram illustrating an example of a hardware configuration of the musical score display control device shown in FIG. 1;

FIG. 3 is a block diagram illustrating an example of a functional configuration of the controller shown in FIG. 2;

FIG. 4 is a block diagram illustrating an example of a functional configuration of a display controller shown in FIG. 3;

FIG. 5 illustrates an example of a musical score for explaining operations of the disclosed embodiments;

FIG. 6 illustrates an example of a display by the display of the musical score display control device for explaining the operations in the disclosed embodiments; and

FIG. 7 is a flow chart illustrating an example of operations performed by the musical score display control device according to disclosed embodiments.

It should be noted that these figures are intended to illustrate the general characteristics of methods and structure utilized in the illustrative embodiment and to supplement the written description provided below. These drawings may not precisely reflect the precise structural or performance characteristics of any given embodiment, and should not be interpreted as defining or limiting the range of values or properties encompassed by illustrative embodiments unless specified.

### DETAILED DESCRIPTION OF EMBODIMENTS

Selected embodiments will now be explained with reference to the drawings. It will be apparent to those skilled in the music field from this disclosure that the following descriptions of the embodiments are provided for illustration only and not for the purpose of limiting the invention as defined by the appended claims and their equivalents. Like reference numerals in the drawings denote like similar or identical elements or features, and thus the descriptions of the similar or identical elements or features may be omitted in later embodiments.

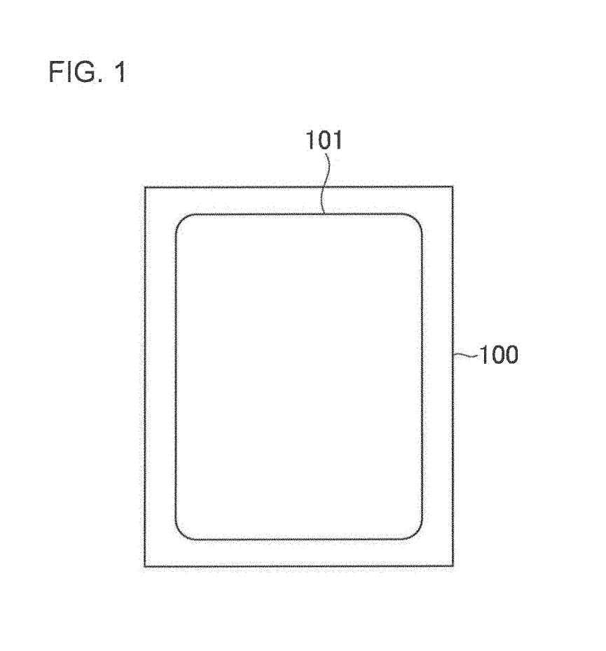

FIG. 1 is a view showing one example of a musical score display control device according to a disclosed embodiment. The musical score display control device 100 comprises a display 101 (e.g., a touch panel). Information can be input to the musical score display control device 100 by, for example, a user performing a contact operation on the display 101 with a finger or the like (hereinafter referred to as “touch”). Specifically, the musical score display control device 100 can be configured as a mobile electronic device, such as a PDA (Personal Digital Assistant), a mobile terminal, a smart phone, a tablet computer, and any other suitable type of device as understood in the art. For example, a smart phone or tablet computer can use an application that enables the smart phone or tablet computer to operate as the musical score display control device 100 as described herein. Moreover, the display 101 can include, for example, electrostatic capacitive coupling components that detect changes in capacitance of the touched portion, a resistance film that detects changes in resistance of the touched portion, a light sensor that detects changes in the amount of light of the portion that is shielded by touch, or the like.

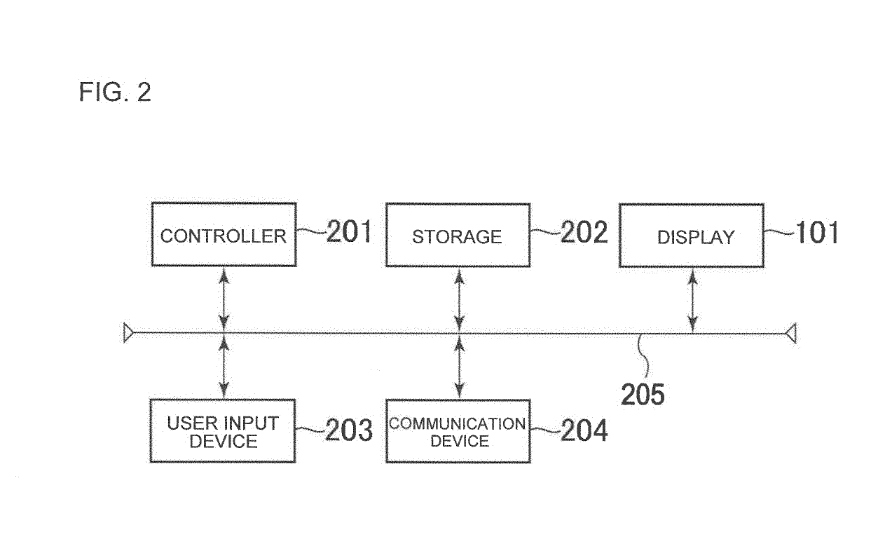

FIG. 2 is a block diagram illustrating an example of a hardware configuration of the musical score display control device 100. As shown in FIG. 2, the musical score display control device 100 comprises a controller 201, a storage 202, a user input device 203, a display 101, and a communication device 204. Moreover, each of the controller 201, the storage 202, the user input device 203, the communication device 204 and the display 101 are connected to each other by, for example, an internal bus 205 or in any other suitable manner.

The controller 201 includes, for example, a CPU (also referred to herein as a processor), which is operated according to a program that is stored in the storage 202, which can be referred to as a non-transitory computer-readable medium as understood in the art. As further understood in the art, the CPU preferably includes a microcomputer with a control program that controls the musical score display control device 100 as discussed herein. The CPU can also include other conventional components such as an input interface circuit, an output interface circuit, and storage devices such as a ROM (Read Only Memory) device and a RAM (Random Access Memory) device. The RAM and ROM store processing results and control programs that are run by the CPU. The CPU is operatively coupled to the components of the musical score display control device 100 as appropriate, in a conventional manner. It will be apparent to those skilled in the art from this disclosure that the precise structure and algorithms for the CPU can be any combination of hardware and software, such an application, that will carry out the functions of the present invention. The storage 202 is configured from information storage media, such as ROM, RAM, and a hard disk, and is an information storage medium that holds programs that are executed by the controller 201. In addition, the storage 202 also operates as a work memory of the controller 201. Moreover, the programs can be provided by downloading via a network, or provided by various information storage media that can be read by a computer, such as a CD-ROM, a DVD-ROM or any other suitable storage medium as known in the art.

The user input device 203 is configured as a so-called touch panel integrated with the display 101 described below, and outputs the content of an instruction operation of the user according to the instruction operation to the controller 201. The display 101 is, for example, a liquid crystal display, an organic EL display, or the like, and displays information in accordance with instructions from the controller 201. The communication device 204 communicates with, for example, an external device (not shown). Moreover, while the user input device 203 and the display 101 are shown separately in FIG. 2, in the present embodiment, for example, the user input device 203 and the display 101 are integrally formed as a touch panel. Further, the present embodiment can be configured so as to comprise one or more buttons, or the like, as a user input device 203 other than a touch panel.

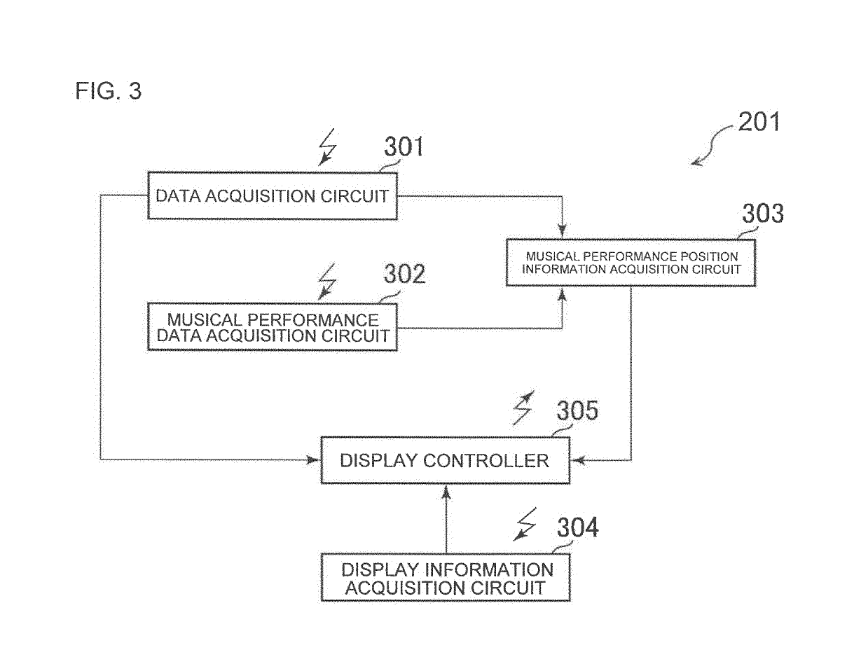

Next, one example of a functional configuration of the controller 201 shown in FIG. 2 will be described with regard to FIG. 3. The controller 201 comprises a data acquisition circuit 301, a musical performance data acquisition circuit 302, a musical performance position information acquisition circuit 303, a display information acquisition circuit 304, and a display controller 305. As understood by one skilled in the art, the operations of the controller 201, the data acquisition circuit 301, the musical performance data acquisition circuit 302, the musical performance position information acquisition circuit 303, the display information acquisition circuit 304, and the display controller 305 described herein are performed by the processor (CPU) of the controller 201 in this example.

The data acquisition circuit 301 acquires musical score data. The musical score data can be, for example, data for displaying a musical score on the display 101. More specifically, for example, the musical score data correspond to image data or MusicXML data that represent a musical score. Moreover, the data acquisition circuit 301 can carry out image recognition of symbols such as musical notes from image data that represent a musical score, and generate MusicXML data based on the recognized image data. Further, in this case, the musical score display control device 100 in the disclosed embodiments can be configured to comprise a camera and to acquire image data of a musical score by photographing a musical score.

The musical performance data acquisition circuit 302 acquires performance data being performed. Here, performance data are data based on the performance of an instrument, or the like, by the user, and correspond to, for example, audio data that are based on the performance of an instrument. Specifically, for example, the musical performance data acquisition circuit 302 acquires audio data that are output from an instrument, a microphone, or the like, at predetermined intervals as performance data. Further, for example, the performance data can be configured to correspond to musical sound information that represents each musical sound, when the instrument is an electronic instrument such as an electronic piano.

The musical performance position information acquisition circuit 303 acquires performance position information, which represents the performance position of the performance in the musical score data, based on the musical score data and the performance data. Specifically, for example, the current performance position in the musical score data is inferred by analyzing and comparing the performance data and the musical score data, and is acquired as performance position information. Moreover, well-known technology disclosed in the above-described Japanese Laid-Open Patent Publication No. 2001-265325, Japanese Laid Open Patent Application No. 2015-079183, etc., can be used in order to infer the performance position. In addition, the performance position information is configured from, for example, numerical value information, etc., that represents a time axis from the performance start position in the musical score data. Moreover, when the current performance position in the musical score data is to be inferred, the current performance position in the musical score data can be inferred and acquired as performance position information by analyzing and comparing the performance data, based on music data (for example, MIDI data and SMF data) corresponding to the music that is represented by the musical score data and on reference data with which position information indicated by the musical score data and time information indicated by the music data are associated. In this case, the data acquisition circuit 301 can acquire the music data and the reference data in addition to the musical score data.

The display information acquisition circuit 304 acquires, for example, display portion information, which represents the displayed portion when the displaying is occurring, such as displaying the musical score data configured from a plurality of pages half a page at a time, one page at a time, or the like. In the disclosed embodiments, the display portion information can, for example, be configured to be set by the user, or can be configured in another manner, such as being determined according to the musical score data.

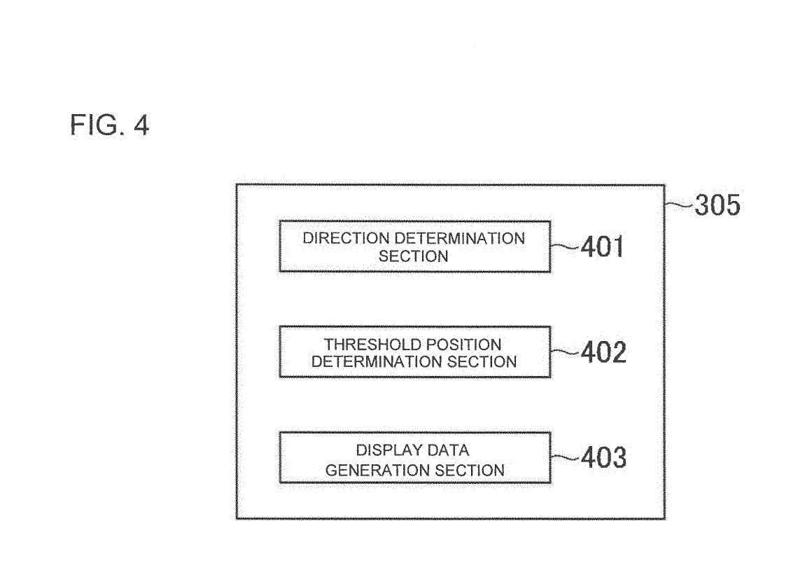

The display controller 305 displays the musical score data corresponding to the current performance position by the displayed portion indicated by the display portion information, according to the current performance position. As shown in FIG. 4, the display controller 305 comprises a direction determination section 401, a threshold position determination section 402, and a display data generation section 403. As understood by one skilled in the art, the operations of the direction determination section 401, the threshold position determination section 402, and the display data generation section 403 described herein are performed by the processor (CPU) of the controller 201 in this example.

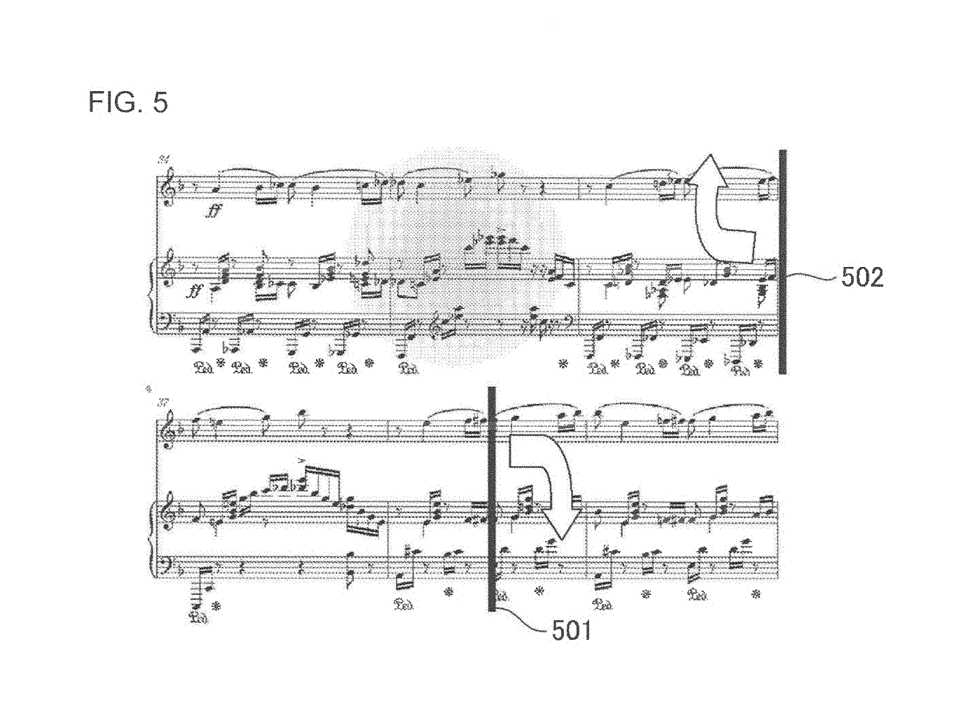

The example shown in FIG. 5 is used in the description below to facilitate understanding. That is, FIG. 5 shows a case in which first and second grand staffs, which are a part of one page of a musical score represented by the musical score data, are displayed as a displayed portion. In FIG. 5, 501 represents a first threshold position and 502 represents a second threshold position. Details of the first threshold position 501 and the second threshold position 502 will be described below. Further, the first threshold position 501 and the second threshold position 502 in FIG. 5 are shown merely to facilitate understanding of the operation of the embodiments, and are not actually displayed.

In the example shown in FIG. 5, the first threshold position 501 is arranged in a position that has advanced from the second threshold position 502 in the performance direction of the musical score. Furthermore, the displayed portion in FIG. 5 is a display of a first grand staff and a second grand staff, and the first threshold position 501 in this example is positioned substantially in the center of the second grand staff. In addition, the second threshold position 502 in this example, is positioned between the first grand staff and the second grand staff (i.e., at the rightmost end of the first grand staff).

The direction determination section 401 determines whether the current performance position has advanced or has returned in the performance direction from the immediately prior performance position on the musical score data, based on the current performance position and the immediately prior performance position, as indicated by the performance position information that is acquired by the musical performance position information acquisition circuit 303. In the case shown in FIG. 5, for example, if the current performance position is in a position that has advanced in the performance direction of the musical score from the immediately prior performance position in the grand staff, the direction determination section 401 determines that the current performance position has advanced from the immediately prior performance position on the musical score data. On the other hand, if the current performance position is in a position that is in the opposite direction of the performance direction of the musical score with respect to the immediately prior performance position in the grand staff, the direction determination section 401 determines that the current performance position has returned from the immediately prior performance position on the musical score data.

In addition, the above-described determination is configured so that, for example, if the performance position information is represented by numerical value information that represents the time axis from the performance start position in the musical score data, the performance position information that represents the current performance position and the performance position information that represents the immediately prior performance position are compared. If the numerical value of the performance position information that represents the current performance position is greater than the numerical value of the performance position information that represents the immediately prior performance position, the direction determination section 401 determines that the current performance position has advanced from the immediately prior performance position on the musical score data. Further, if the numerical value of the performance position information that represents the current performance position is smaller than the numerical value of the performance position information that represents the immediately prior performance position, the direction determination section 401 determines that the current performance position has returned from the immediately prior performance position on the musical score data.

If the direction determination section 401 determines that the current performance position has advanced from the immediately prior performance position on the musical score data, the threshold position determination section 402 determines whether or not the first threshold position 501 is positioned between the current performance position and the immediately prior performance position indicated by the performance position information that is acquired by the musical performance position information acquisition circuit 303. Further, if the direction determination section 401 determines that the current performance position has returned from the immediately prior performance position on the musical score data, the threshold position determination section 402 determines whether or not the second threshold position is positioned between the current performance position and the immediately prior performance position indicated by the performance position information that is acquired by the musical performance position information acquisition circuit 303.

For example, in the case shown in FIG. 5, if the current performance position is positioned on the right side of the first threshold position 501 in the second grand staff (as indicated by the downward pointing arrow in FIG. 5), and the immediately prior performance position is positioned on the left side of the first threshold position 501 in the second grand staff, the threshold position determination section 402 determines that the first threshold position 501 is positioned between the current performance position and the immediately prior performance position. On the other hand, if the immediately prior performance position is positioned in the second grand staff, and the current performance position is positioned on the left side of the second threshold position 502 (as indicated by the upward pointing arrow in FIG. 5), which is arranged at the right end of the first grand staff, the threshold position determination section 402 determines that the second threshold position 502 is positioned between the current performance position and the immediately prior performance position.

Furthermore, the determination described above is configured so that, for example, the performance position information is represented by numerical value information that represents the time axis from the performance start position in the musical score data. When the numerical value that is indicated by the first threshold position 501 is a numerical value that is between the numerical value of the performance position information that represents the current performance position and the numerical value of the performance position information that represents the immediately prior performance position, the threshold position determination section 402 determines that the first threshold position 501 is positioned between the current performance position and the immediately prior performance position indicated by the performance position information that is acquired by the musical performance position information acquisition circuit 303. Similarly, when the numerical value that is indicated by the second threshold position 502 is a numerical value that is between the numerical value of the performance position information that represents the current performance position and the numerical value of the performance position information that represents the immediately prior performance position, the threshold position determination section 402 determines that the second threshold position 502 is positioned between the current performance position and the immediately prior performance position indicated by the performance position information that is acquired by the musical performance position information acquisition circuit 303.

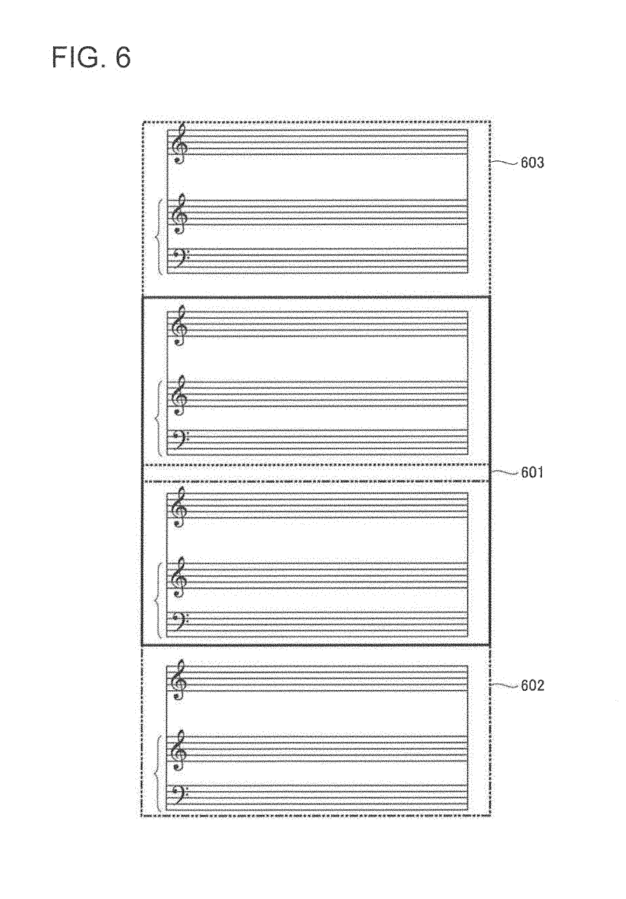

When the threshold position determination section 402 determines that the first threshold position 501 is positioned between the current performance position and the immediately prior performance position indicated by the performance position information, the display data generation section 403 causes the display 101 to display musical score data of a displayed portion that corresponds to the next performance target on the musical score data. For example, the first and second grand staff that are to be played after the second grand staff shown in FIG. 5 are displayed. In other words, for example, in a case in which one page of the musical score of the musical score data is as shown in FIG. 6, when the area of the page indicated by 601 (i.e., the area surrounded by the solid line designated by 601) corresponds to the displayed portion shown in FIG. 5, the area indicated by 602 in FIG. 6 is displayed as this next performance target (i.e., the area surrounded by the chain dashed line designated by 602).

On the other hand, when the threshold position determination section 402 determines that the first threshold position 501 is not positioned between the current performance position and the immediately prior performance position indicated by the performance position information, the display of the musical score data of the current displayed portion is maintained. That is, the display shown in FIG. 5 is maintained, which corresponds to the area indicated by 601 in FIG. 6.

Furthermore, when the threshold position determination section 402 determines that the second threshold position 502 is positioned between the current performance position and the immediately prior performance position indicated by the performance position information as discussed above with regard to FIG. 5, the display data generation section 403 causes the display 101 to display musical score data of a displayed portion that corresponds to the previous performance target on the musical score data. For example, in the case shown in FIG. 5, the first and second grand staff that are to be played before the second grand staff shown in FIG. 5 are displayed. In other words, in a case in which one page of the musical score of the musical score data is as shown in FIG. 6, when the area indicated by 601 corresponds to the displayed portion of FIG. 5, the area indicated by 603 is displayed (i.e., the area surrounded by the dashed line designated by 602).

On the other hand, when the threshold position determination section 402 determines that the second threshold position 502 is not positioned between the current performance position and the immediately prior performance position indicated by the performance position information, the display of the musical score data of the current displayed portion is maintained. In the foregoing example, the display shown in FIG. 5 is maintained, which corresponds to the area indicated by 601 in FIG. 6.

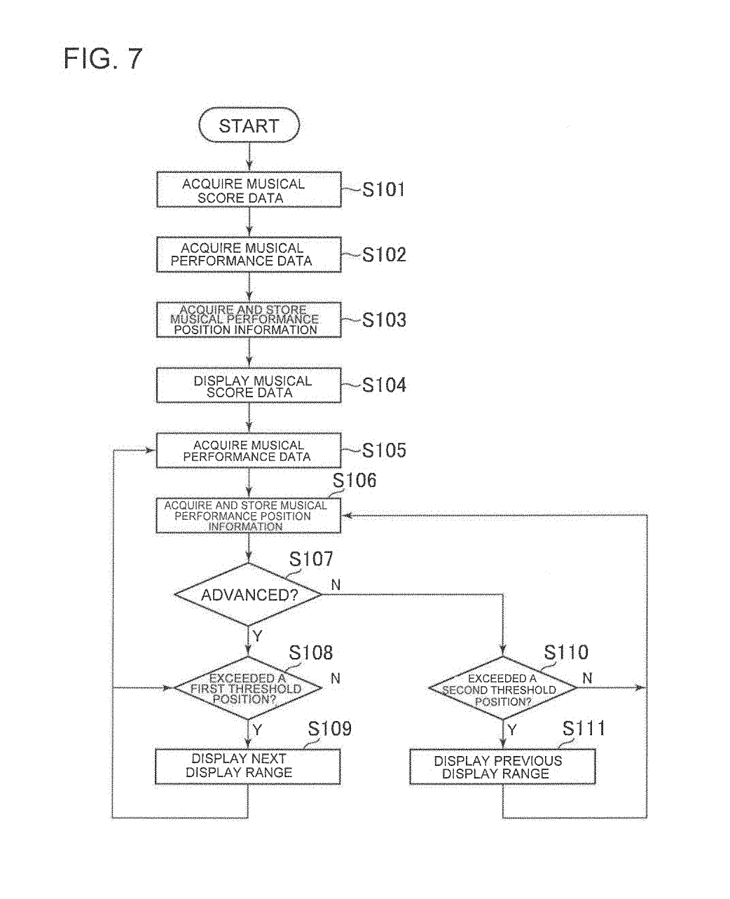

An example of operations performed by the musical score display control device 100 according to disclosed embodiments will now be described with reference to FIG. 7. As shown in the flowchart of FIG. 7, the data acquisition circuit 301 first acquires musical score data in Step S101. In Step S102, the musical performance data acquisition circuit 302 then acquires performance data being performed. In Step S103, the musical performance position information acquisition circuit 303 acquires and stores performance position information, which represents the current performance position in the musical score data, based on the musical score data and the performance data. In Step S104, the display controller 305 displays the musical score data by a predetermined displayed portion, according to the performance position information acquired in Step S103.

In Step S105, the musical performance data acquisition circuit 302 again acquires performance data being performed. In Step S106, the musical performance position information acquisition circuit 303 acquires and stores performance position information, which represents the current performance position in the musical score data, based on the musical score data and the performance data.

In Step S107, the direction determination section 401 determines whether the current performance position has advanced or returned from the immediately prior performance position, based on the current performance position (for example, the performance position acquired in Step S106) and the immediately prior performance position (for example, the performance position acquired in Step S103).

When the direction determination section 401 determines in Step S107 that the positioned has advanced, the threshold position determination section 402 determines in Step S108 whether or not the current performance position (for example, the performance position acquired in Step S106) has gone past the first threshold position 501 relative to the immediately prior performance position (for example, the performance position acquired in S103). If the threshold position determination section 402 determines that the current performance position has gone past the first threshold position 501, the display controller 305 causes musical score data of a displayed portion, which becomes the next performance target, to be displayed in Step S109. Then, the process returns to Step S105. On the other hand, if the threshold position determination section 402 determines in Step S108 that the current performance position has not gone past the first threshold position 501, the process returns to Step S105 without performing Step S109.

However, when the direction determination section 401 determines in Step S107 that the current performance position has returned (the case of N in Step S107), the threshold position determination section 402 determines in Step S110 whether or not the current performance position (for example, the performance position acquired in S106) has gone past the second threshold position 502 relative to the immediately prior performance position (for example, the performance position acquired in S103). If the threshold position determination section 402 determines that the current performance position has gone past the second threshold position 502, the display controller 305 causes musical score data of the previous displayed portion to be displayed in Step S111. Then, the process returns to Step S105. On the other hand, if the threshold position determination section 402 determines in Step S110 that the current performance position has not gone past the second threshold position 502, then the process returns to Step S105 without performing Step S111.

As can be appreciated from the above, the disclosed embodiments make it possible to prevent the user from experiencing difficulty reading, for example, when a transition of display is executed with respect to one threshold position and when the performance position goes back and forth across the one threshold position (for example, a transition to a display of the first and second grand staff that are to be played after or before the second grand staff shown in FIG. 5). Also, if the current performance position is frequently moved across the first and the second threshold positions 501 and 502, it is possible to suppress a transition in the display even compared to when controlling a transition in the display with the one threshold position. More specifically, according to the disclosed embodiments, if the current performance position is moved from the immediately prior performance position across the first threshold position 501, the display changes from the area indicated by 601 to the area indicated by 602 in FIG. 6. Thereafter, in the area indicated by 602 in FIG. 6, even if the current performance position returns from the immediately prior performance position across the first threshold position 501, the area indicated by 602 is maintained.

The present invention is not limited to the embodiments described above, and can be replaced by a configuration that is substantially the same, a configuration that realizes the same action and effect, or a configuration that is capable of achieving the same object as the configuration shown in the above-described embodiment. For instance, in the embodiments described above, a first and second grand staff of the musical score is displayed. However, other displays of the musical score can be employed in the disclosed embodiments as can be appreciated by one skilled in the art.

### General Interpretation of Terms

In understanding the scope of the present invention, the term “detect” as used herein to describe an operation or function carried out by a component, a section, a device or the like includes a component, a section, a device or the like that does not require physical detection, but rather includes determining, measuring, modeling, predicting or computing or the like to carry out the operation or function. The term “configured” as used herein to describe a component, section or part of a device includes hardware and/or software that is constructed and/or programmed to carry out the desired function. The terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A musical score display control method comprising:
acquiring by a processor performance data being performed;
sequentially acquiring by the processor performance positions, including a current performance position, of a performance in a musical score data that represent a musical score based on the musical score data and the performance data;
displaying on a display a predetermined portion of the musical score data as controlled by the processor according to the current performance position acquired by the processor;
displaying on the display a next performance target portion of the musical score data, corresponding to a next performance target on the musical score data, as controlled by the processor upon the processor determining that the current performance position has advanced beyond a first threshold position from a prior performance position at a point in time in the musical score data prior to the current performance position; and
displaying on the display a previous performance target portion of the musical score data, corresponding to a previous performance target on the musical score data, as controlled by the processor upon the processor determining that the current performance position has returned beyond a second threshold position from the prior performance position.

2. The musical score display control method according to claim 1, further comprising
determining by the processor whether the first threshold position or the second threshold position is present between the current performance position and the prior performance position to determine whether the current performance position has advanced beyond the first threshold position or has returned beyond the second threshold position.

3. The musical score display control method according to claim 1, wherein
the first threshold position is at a position that is advanced from the second threshold position in a performance direction in the musical score data.

4. The musical score display control method according to claim 2, wherein
the first threshold position is at a position that is advanced from the second threshold position in a performance direction in the musical score data.

5. The musical score display control method according to claim 1, wherein
the predetermined portion is a display of a grand staff in the musical score, with the display including first grand staff portion of the grand staff and a second grand staff portion of the grand staff displayed below the first grand staff portion;
the first threshold position is positioned substantially at a center of the second grand staff portion; and
the second threshold position is positioned on the grand staff between the first grand staff portion and the second grand staff portion.

6. The musical score display control method according to claim 2, wherein
the predetermined portion is a display of a grand staff in the musical score, with the display including first grand staff portion of the grand staff and a second grand staff portion of the grand staff displayed below the first grand staff portion;
the first threshold position is positioned substantially at a center of the second grand staff portion; and
the second threshold position is positioned on the grand staff between the first grand staff portion and the second grand staff portion.

7. The musical score display control method according to claim 3, wherein
the predetermined portion is a display of a grand staff in the musical score, with the display including first grand staff portion of the grand staff and a second grand staff portion of the grand staff displayed below the first grand staff portion;
the first threshold position is positioned substantially at a center of the second grand staff portion; and
the second threshold position is positioned on the grand staff between the first grand staff portion and the second grand staff portion.

8. A musical score display controller comprising:
a processor, programmed to
acquire performance data being performed;
sequentially acquire performance positions, including a current performance position, of a performance in a musical score data that represent a musical score based on the musical score data and the performance data;
control a display to display a predetermined portion of the musical score data according to the current performance position acquired by the processor;
control the display to display a next performance target portion of the musical score data, corresponding to a next performance target on the musical score data, upon the processor determining that the current performance position has advanced beyond a first threshold position from a prior performance position at a point in time in the musical score data prior to the current performance position; and
control the display to display a previous performance target portion of the musical score data, corresponding to a previous performance target on the musical score data, upon the processor determining that the current performance position has returned beyond a second threshold position from the prior performance position.

9. The musical score display controller according to claim 8, wherein
the processor is further configured to determine whether the first threshold position or the second threshold position is present between the current performance position and the prior performance position, to determine whether the current performance position has advanced beyond the first threshold position or has returned beyond the second threshold position.

10. The musical score display controller according to claim 8, wherein
the first threshold position is at a position that is advanced from the second threshold position in a performance direction in the musical score data.

11. The musical score display controller according to claim 9, wherein
the first threshold position is at a position that is advanced from the second threshold position in a performance direction in the musical score data.

12. The musical score display controller according to claim 8, wherein
the predetermined portion is a display of a grand staff in the musical score, with the display including first grand staff portion of the grand staff and a second grand staff portion of the grand staff displayed below the first grand staff portion;
the first threshold position is positioned substantially at a center of the second grand staff portion; and
the second threshold position is positioned on the grand staff between the first grand staff portion and the second grand staff portion.

13. The musical score display controller according to claim 9, wherein
the predetermined portion is a display of a grand staff in the musical score, with the display including first grand staff portion of the grand staff and a second grand staff portion of the grand staff displayed below the first grand staff portion;
the first threshold position is positioned substantially at a center of the second grand staff portion; and
the second threshold position is positioned on the grand staff between the first grand staff portion and the second grand staff portion.

14. The musical score display controller according to claim 10, wherein
the predetermined portion is a display of a grand staff in the musical score, with the display including first grand staff portion of the grand staff and a second grand staff portion of the grand staff displayed below the first grand staff portion;
the first threshold position is positioned substantially at a center of the second grand staff portion; and
the second threshold position is positioned on the grand staff between the first grand staff portion and the second grand staff portion.

15. A non-transitory computer-readable medium storing a musical score display control program that is executed by a computer to:
acquire performance data being performed;
sequentially acquire performance positions, including a current performance position, of a performance in a musical score data that represent a musical score based on the musical score data and the performance data;
control a display to display a predetermined portion of the musical score data according to the current performance position acquired by the computer;
control the display to display a next performance target portion of the musical score data, corresponding to a next performance target on the musical score data, upon the computer determining that the current performance position has advanced beyond a first threshold position from a prior performance position at a point in time in the musical score data prior to the current performance position; and
control the display to display a previous performance target portion of the musical score data, corresponding to a previous performance target on the musical score data, upon the computer determining that the current performance position has returned beyond a second threshold position from the prior performance position.

16. The non-transitory computer-readable medium according to claim 15, wherein the musical score display control program is further executed by the computer to
determine whether the first threshold position or the second threshold position is present between the current performance position and the prior performance position, to determine whether the current performance position has advanced beyond the first threshold position or has returned beyond the second threshold position.

17. The non-transitory computer-readable medium according to claim 15, wherein
the first threshold position is at a position that is advanced from the second threshold position in a performance direction in the musical score data.

18. The non-transitory computer-readable medium according to claim 16, wherein
the first threshold position is at a position that is advanced from the second threshold position in a performance direction in the musical score data.

19. The non-transitory computer-readable medium according to claim 15, wherein
the predetermined portion is a display of a grand staff in the musical score, with the display including first grand staff portion of the grand staff and a second grand staff portion of the grand staff displayed below the first grand staff portion;
the first threshold position is positioned substantially at a center of the second grand staff portion; and
the second threshold position is positioned on the grand staff between the first grand staff portion and the second grand staff portion.

20. The non-transitory computer-readable medium according to claim 16, wherein
the predetermined portion is a display of a grand staff in the musical score, with the display including first grand staff portion of the grand staff and a second grand staff portion of the grand staff displayed below the first grand staff portion;
the first threshold position is positioned substantially at a center of the second grand staff portion; and
the second threshold position is positioned on the grand staff between the first grand staff portion and the second grand staff portion.
